(19) United States
(12) Patent Application Publication
(10) Pub. No.: US 2016/0290833 A1
(43) Pub. Date: Oct. 6, 2016

(54) Contactless Sensor

(71) Applicant: Mitsubishi Electric Research Laboratories, Inc., Cambridge, MA (US)

(72) Inventors: Bingnan Wang, Belmont, MA (US); Koon Hoo Teo, Lexington, MA (US)

(21) Appl. No.: 14/677,287

(22) Filed: Apr. 2, 2015

(51) Int. Cl. G01D 5/22

(52) U.S. Cl. CPC G01D 5/2225

(57) ABSTRACT

A sensor includes a source including an electromagnetic structure generating an electromagnetic near-filed upon receiving energy and a detecting unit including at least one coil arranged in proximity to the source such that the electromagnetic near-filed induces, via an inductive coupling, a current passing through the coil. The sensor also includes a measuring unit for measuring a voltage across the coil and a processor for detecting a presence of a target structure in proximity to the source upon detecting a change in a value of the voltage. The target structure is an electromagnetic structure moving at a distance from the source.

### FIELD OF THE INVENTION

The invention relates generally to a position sensor, and more particularly to a contactless sensor for determining a presence and/or relative position of a target structure in a proximity to the sensor.

### BACKGROUND OF THE INVENTION

Position sensors, such as brushes, slip rings, or wire conductors, often employ contacts to indicate the position of a movable member. The elimination of contacts is desirable and can reduce electrical noise and disturbances caused by sliding electric contact. The contactless sensors maintain a gap between the sensor and a target structure. It can be challenging to maintain the sensing range in the presence of such a physical gap.

Examples of contactless sensors include capacitance-based position sensors, laser-based position sensors, eddy-current sensing position sensors, and linear displacement transducer-based position sensors. While each type of position sensor has its advantages, each type of the sensor may be best suited for a particular application. For example, the size of capacitors can make the sensor impractical when the position sensor must be small in size. The optical sensor can fail in the presence of dirt or grease. Magnetic sensors require precision housings and mechanical assembly to avoid errors caused by magnet or sensor misalignment, which can be difficult in some applications. In addition, in some applications, the size of the gap between the sensor and the target structure can change with time, and the location of the target structure can cause problems to the accuracy of some linear position sensors.

Accordingly, there is a need for a contactless sensor for determining a presence and/or relative position of a target structure arranged at a different distances from the sensor.

### SUMMARY OF THE INVENTION

Some embodiments of the invention are based on recognition that the magnetic flux of an electromagnetic near field used during inductive coupling is sensitive to any variations in the electromagnetic near-field. The variations in the electromagnetic near-field caused by the changes of the magnetic flux that can be detected by, e.g., by measuring the voltage of across the coil caused by the current induced by the magnetic flux via inductive coupling.

Some embodiments of the invention are based on realization that a presence of an external electromagnetic structure moving within the electromagnetic near-field disturbs the magnetic field and thus can be detected based on the changes in the measurements of the voltage. For example, the resonant coupling of the target structure that changes the shape of the magnetic near-field, which in turn changes the current in the connected coils generated by that near-filed. Moreover, the effect of such a presence is affects the entire near-filed making such detection less sensitive to the distance between the source generating the near-field and the target structure. In such a manner, the presence of the target structure within the near field, even at a relatively great distance from the source, can be detected.

Moreover, if the magnetic flux induces current over multiple connected coils, then the magnitude and/or differences between the voltages of different coils are indicative of the relative position of the target structure within the near field. For example, a trajectory of potential movement of the target structure can be sampled to determine a combination of voltages of the connected coils corresponding to specific position of the target structure on the trajectory.

Accordingly, one embodiment discloses a sensor including a source including an electromagnetic structure generating an electromagnetic near-filed upon receiving energy; a detecting unit including at least one coil arranged in proximity to the source such that the electromagnetic near-filed induces, via an inductive coupling, a current passing through the coil; a measuring unit for measuring a voltage across the coil; and a processor for detecting a presence of a target structure in proximity to the source upon detecting a change in a value of the voltage, wherein the target structure is an electromagnetic structure moving at a distance from the source.

Another embodiment discloses a sensor including a source including an electromagnetic structure; a power source for supplying a power signal with the resonance frequency to the electromagnetic structure to generate a magnetic near-filed around the electromagnetic structure; a detecting unit including connected coils arranged in proximity to the source such that the magnetic near-filed induces a current passing through the connected coils via an inductive coupling, wherein connected coils includes a first coil and a second coil; a measurement unit for measuring voltages across each connected coils including a first voltage measured across the first coils and a second voltage measured across the second coil; and a processor for comparing the first voltage and the second voltage and for determining a relative position of a target structure with respect to the source or with respect to the pair of connected coils based on a difference between the first and the second voltages.

### BRIEF DESCRIPTION OF THE DRAWINGS

FIG. 1 is a schematic of a sensor according to one embodiment of the invention;

FIG. 2 is a block diagram of a sensor for determining a relative position of the target structure with respect to the sensor according to one embodiment of the invention;

FIG. 3 is a block diagram of a method for determining the relative position of the target structure according to one embodiments of the invention;

FIG. 4 is an example of a mapping between different combinations of the values of the voltages and relative positions of the target structure according to some embodiments of the invention;

FIG. 5A is an example of an electromagnetic structure used by the sensor according to one embodiment;

FIG. 5B is an example of the source structure connected to a power source 290 via two terminals according to one embodiment;

FIG. 6 is an example of a sensing structure including a source structure and a detecting structure.

FIGS. 7A and 7B are examples of different geometrical patterns of the detecting structure according to some embodiments of the invention;

FIGS. 8A and 8B are examples of different geometrical patterns of the detecting structure according to some embodiments of the invention;

FIG. 9 is a schematic of detecting a position of the target structure including multiple resonant structures according to one embodiment of the invention; and

FIG. 10 is a schematic of the sensing structure including a source structure and a set of groups of connected coils of the detecting unit according to one embodiment of the invention.

### DETAILED DESCRIPTION OF THE PREFERRED EMBODIMENTS

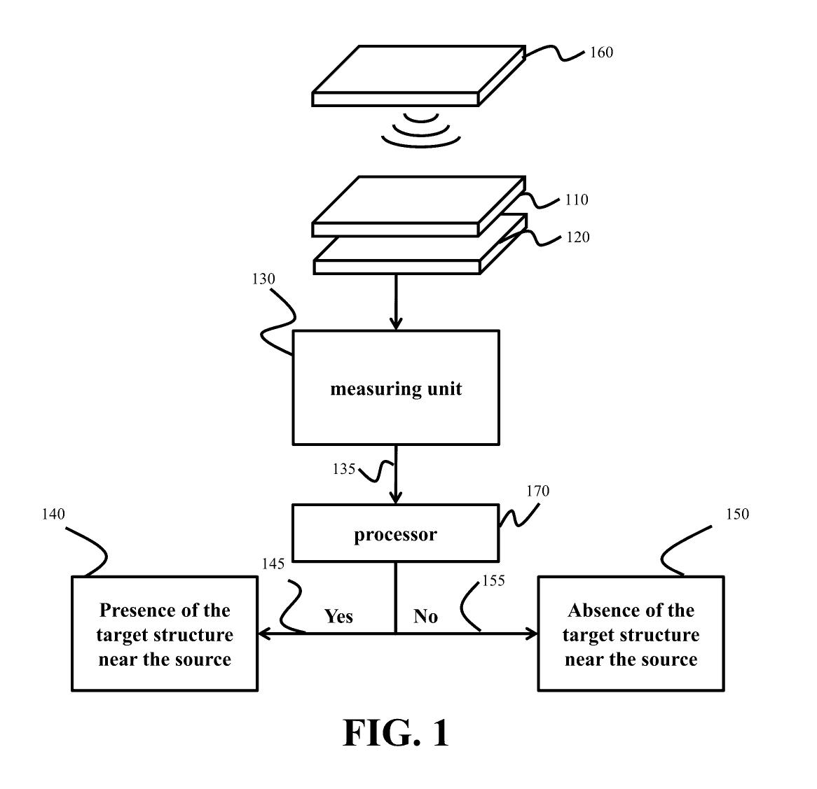

FIG. 1 shows a schematic of a sensor according to one embodiment of the invention. The sensor includes a source 110 including an electromagnetic structure for generating an electromagnetic near-filed upon receiving energy and a detecting unit 120 including at least one coil arranged in proximity to the source such that the electromagnetic near-filed induces, via an inductive coupling, a current passing through the coil. The sensor also includes a measurement unit 130 for measuring a voltage across the coil of the detecting unit. In some embodiments, the voltage is measured directly. In alternative embodiments the voltage is measured through other measurements that analytically define the voltage, e.g., the measurements of the current.

Some embodiments of the invention are based on realization that a presence of external electromagnetic structure, such as a target structure 160 moving within the electromagnetic near-field disturbs the magnetic field and thus can be detected based on the changes in the measurements of the voltage. For example, the resonant coupling of the target structure that changes the shape of the magnetic near-field, which in turn changes the current in the connected coils generated by that near-filed. Moreover, the effect of such a presence is felt within the entire near-filed making such detection less sensitive to the distance between the source generating the near-field and the target structure. In such a manner, the presence of the target structure within the near field even at a relatively great distance from the source can be detected.

Accordingly, the presence 140 or absence 150 of the target structure 160 in proximity to the source 110 can be determined, using a processor 170, based on detecting 145 or not detecting 155 a change 135 in a value of the voltage.

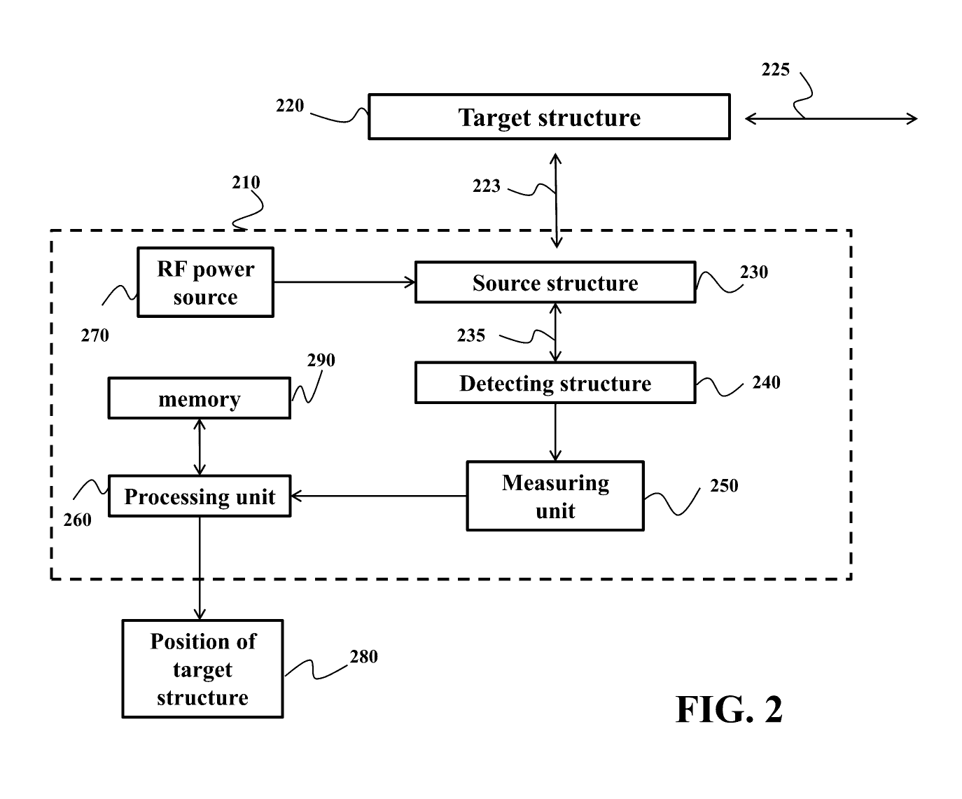

FIG. 2 shows a block diagram of a sensor 210 for determining a relative position of a target structure 220 according another embodiment of the invention. In some implementations the target structure and the sensor include flat surfaces facing each other. The target structure includes at least one passive resonant structure that has resonance at certain radio frequency f₀. In some embodiments, the movement of the target structure is unrestricted. In alternative embodiments, the target structure moves according to a trajectory 225, e.g., in a plane parallel to the flat surface of the sensor.

The sensor includes source including a source structure 230 and a detecting unit including a detecting structure 240. The source structure is an electromagnetic structure generating an electromagnetic near-filed upon receiving energy. For example, the source structure is an electric current carrying coil. The detecting structure is at least one coil arranged. In some embodiments, the detecting structure includes a pair or more of connected coils.

The source structure 230 is inductively coupled 235 with the detecting structure 240 and can be integrated onto one dielectric substrate, such that the relative position of the source and detecting structures is fixed. The source structure can be fed by a radio frequency power source 270. For example, in one embodiment, the power source 270 can supply the energy to the source via a power signal having the same resonance frequency as the target structure. In this embodiment, the target structure can be resonantly coupled 223 to the source structure.

Upon receiving the energy, the magnetic flux passes through each coil of the detecting structure and generates an induced voltage across each coil. The induced voltages of the coil pair are recorded by a measurement unit 250. The voltage information is submitted to a processing unit 260 and the magnitudes of the voltages and/or the difference of the voltages is used to determine the position 280 of the target structure.

For example, when the source structure receives an alternating current, a magnetic near field is generated in the vicinity of the source structure. When the detecting structure is in the vicinity of the source structure, the magnetic flux passes through the coils of the detecting structure and the induced voltage is generated at each coil. When the detecting structure is arranged such that the same amount of the magnetic flux passes through each coil, the induced voltages across each coils are the same. For example, if the connected coils include a first coil and a second coil, a difference between a first voltage across the first coils and a second voltage across the second coil is zero.

When a target structure is placed in the near field of the source structure, the resonance of target structure can be excited, and the magnetic field is coupled to the target structure. Current is induced in the target structure, which generates an induced magnetic field. Due to the resonance in target structure, the induced magnetic field can cause disruption in the overall magnetic flux going through each of the detecting coil. Depending on the relative position of the target structure to the sensing structure, the change in the magnetic flux distribution caused by the target structure is different and the induced voltage at each detecting coil is different. The difference in induced voltage can then be used as an indication of the position of target structure.

For example, if a center of the target structure is aligned with the center of the detecting structure, then the effect of the magnetic flux generated by the target structure to each coil is the same, thus the induced voltages are still the same and the differential voltage is zero. When there is an offset between the center of target structure and that of the detecting structure, the effect of magnetic flux generated by the target structure is asymmetric on the two detecting coils resulting in a non-zero differential voltage. In general, the larger is the offset, the larger the differential voltage. The relationship between a differential voltage value and corresponding relative position can be determined, e.g., by experiment data, which can be stored in a memory 290 operatively connected to a processor of the processing unit. A measured differential voltage value is sent to the processing unit, which then maps this value to the corresponding position information.

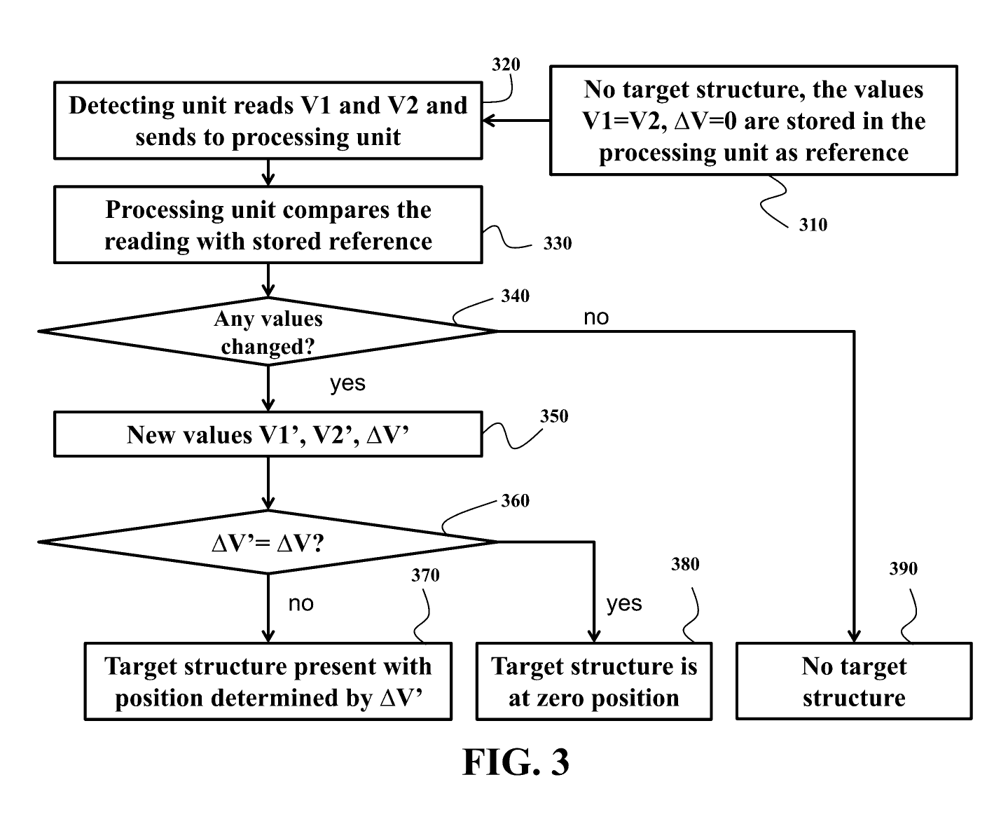

FIG. 3 shows a block diagram of a method for determining the relative position of the target structure according to one embodiments of the invention. When there is no target structure in the vicinity of the sensing structure 310, the induced voltages V1 and V2 are generated 320 due to the magnetic field from the source structure. When the detecting structure is arranged such that the magnetic flux goes through each coil is the same, the induced voltages are the same, and the difference in voltage ΔV is zero. When there is an offset between detecting structure and source structure, there can be a difference between V1 and V2, making ΔV a non-zero value. The information can be stored 330 in the processing unit as reference values.

The sensor continuously measures 340 new values of V1, V2, and ΔV, which are sent to the processing unit for comparison with stored reference values. If there is no change detected, then there is no target structure in range 390. If there is change in measured values 350, then these values are analyzed by the processing unit. If both V1 and V2 are changed, but the new differential voltage ΔV′ is still the same ΔV 360, then the target structure is aligned with the sensing structure, and is at zero position. If the new differential voltage value ΔV′ is different than ΔV, then the target structure is in range of the sensor, and is not aligned with zero position 370. The position information is then determined by the processing unit using pre-stored relationship between differential voltage and position.

Some embodiments of the invention are based on realization that when the magnetic flux induces current through multiple connected coils, the magnitude and/or differences between the voltages of different coils are indicative of the relative position of the target structure within the near field. For example, a trajectory of potential movement of the target structure can be sampled to determine a combination of voltages of the connected coils corresponding to specific position of the target structure on the trajectory. Accordingly, some embodiments of the invention determine a mapping between information indicative of different combination of the values of the voltages across the coils of the detecting unit a relative position of the target structure.

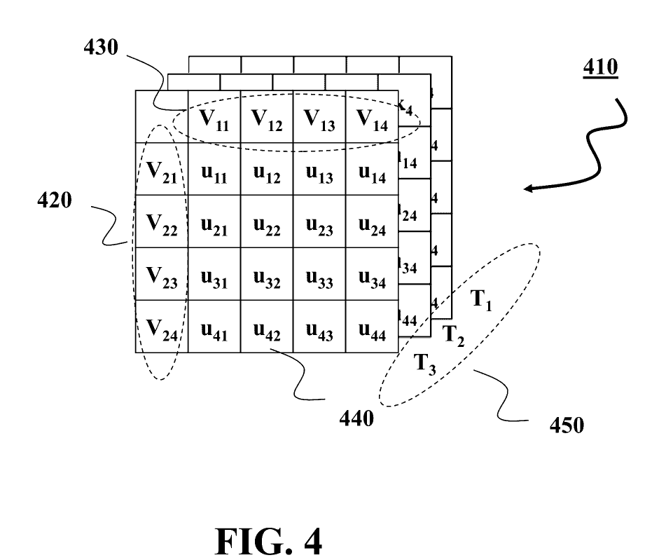

FIG. 4 shows an example of the mapping 410 between different combinations of the values of the voltages 420 and 430 across the coils of the detecting unit and relative positions 440 of the target structure according to some embodiments of the invention. In different embodiments, the mapping is determined for different values of the voltages, differences between the voltages or both. In some embodiments, the mapping is determined for different positions in space around the sensor. In alternative embodiments, the mapping is determine for trajectories 450, e.g., in a plane parallel to the electromagnetic structure of the source.

For example, in one embodiment, the detecting unit includes a pair of connected coils including a first coil and a second coil. The measurement unit measures a difference between a first voltage across the first coils and a second voltage across the second coil, and wherein the processor determines a relative position of the target structure with respect to the source based on the value of the voltage. In some implementations, the resonant structure moves according to a trajectory in a plane parallel to the electromagnetic structure of the source, and the memory 290 stores a mapping between a set of positions of the target structure on the trajectory and a set of values of the measured voltages.

In another embodiment, the measurement unit measures the voltage across each connected coils including a first voltage measured across the first coils and a second voltage measured across the second coil. In one implementation of this embodiment, the memory stores a mapping between a set of positions of the target structure on the trajectory and a set of corresponding differences between the first and the second voltages. In alternative implementation, the memory a mapping 410 between a set of different relative positions 440 of the target structure and a set of corresponding pairs of values of the first 410 and the second 420 voltages.

An advantage of using differential measurements is the tolerance to the change in gap between target structure and sensing structure. As the effect of the magnetic flux on the induced voltage of the two detecting coils is the same even with different gap sizes. The induced voltages V1 and V2 changes simultaneously, and the differential voltage V1−V2 is maintained the same. Such sensors can be used as a position switch, in which case just the zero point is detected by the sensor based on zero differential voltage, or a linear position sensor, in which case the linear position around the zero point is detected by the change in differential voltage. An advantage of using resonant structures coupled to the sensing structure is that the range can be much larger than conventional inductive coupling, such that greater gap size between target structure and sensing structure is allowed.

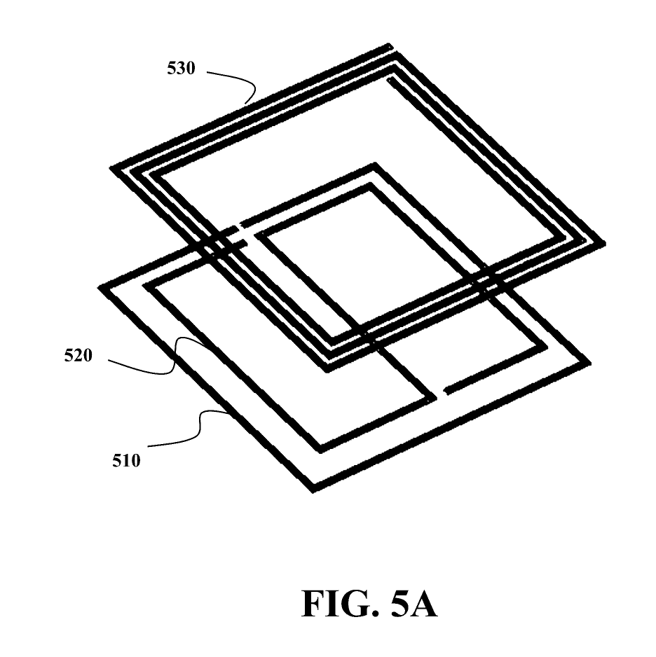

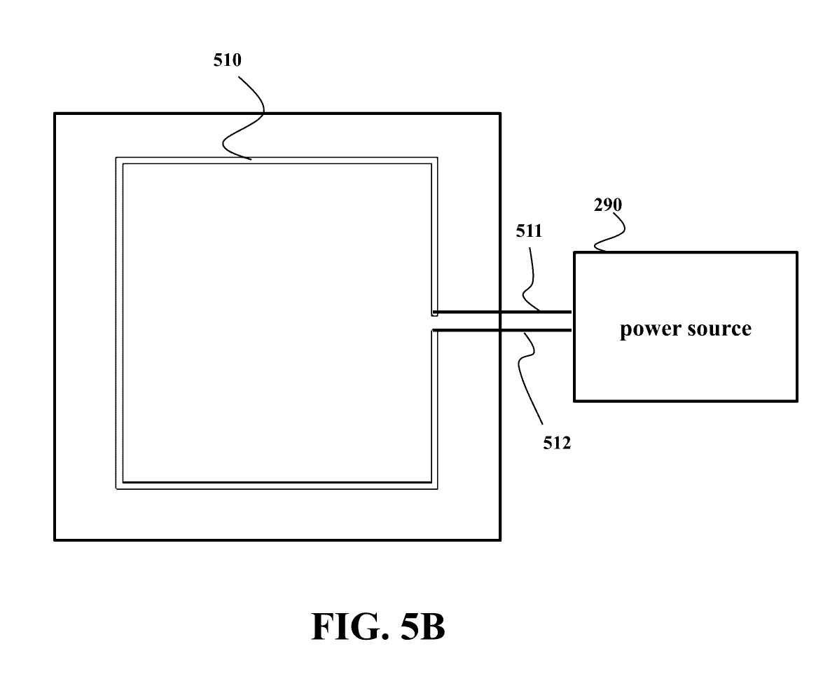

FIG. 5A shows an example of different electromagnetic structure used by the sensor according to one embodiment. In this example, the source structure 510 is a single turn square loop of copper wire, which is connected to a power source at the two terminals. The detecting structure 520 is an 8-shaped copper coil, which is place on the same printed circuit board as source structure 510. The voltages at the two openings of the detecting structure 520 are measured. The target structure 530 is a multi-turn square spiral, and is printed on another circuit board, and is separated by a distance d from the source structure.

FIG. 5B shows an example of the source structure 510 connected to a power source 290 via two terminals 511 and 512. However, different embodiments use different configurations of the source structure 510. For example, some embodiments use the source structure formed by metallic wires of multiple turns, which can be of thin and flat forms as used in printed circuit boards or can be built by stranded wires or Litz wires.

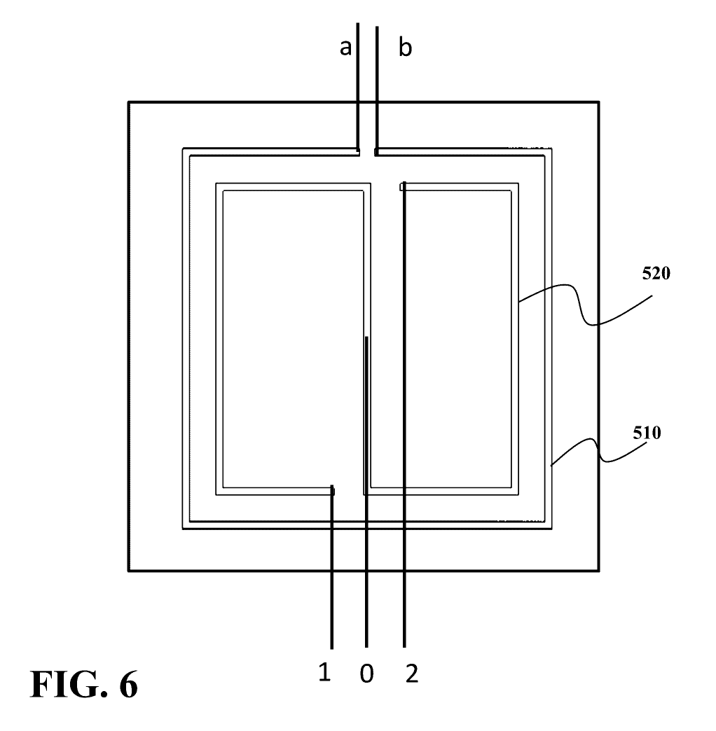

FIG. 6 shows an example of a source structure 510 and a detecting structure 520. The voltages cross terminals 1 and 0, and 2 and 0, are measured as V1 and V2. In this example, the detecting structure is an 8-shaped coil. Similarly to the source structures, the detecting structure can be implemented with many different forms. For example, some embodiments use the source structure formed by metallic wires of multiple turns, which can be of thin and flat forms as used in printed circuit boards or can be built by twisted strands of wires or Litz wires. The detecting structures can have different geometrical patterns.

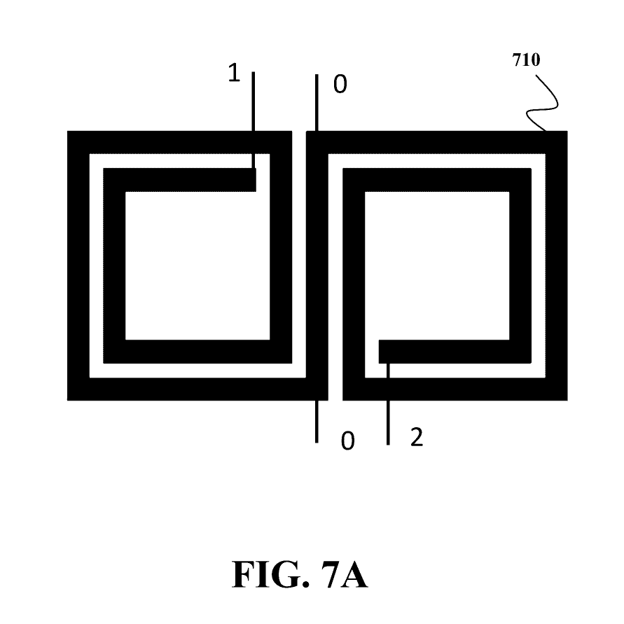

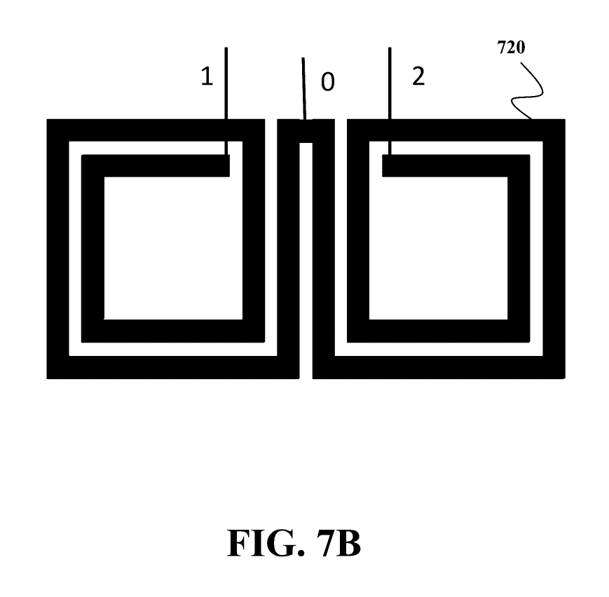

FIGS. 7A and 7B shows examples of different geometrical patterns of the detecting structure according to some embodiments of the invention. The detecting structure 710 of FIG. 7A is an 8-shape coil with multiple turns. The detecting structure 720 of FIG. 7B is made by two multi-turn spirals connected at the end.

In some embodiments of the invention, the target structure is resonant at operating frequency. Various embodiments design the target structure with high quality factor to extend the sensing range. The resonant target structure can also take many different forms to be implemented at printed circuit boards or as stranded or Litz wires.

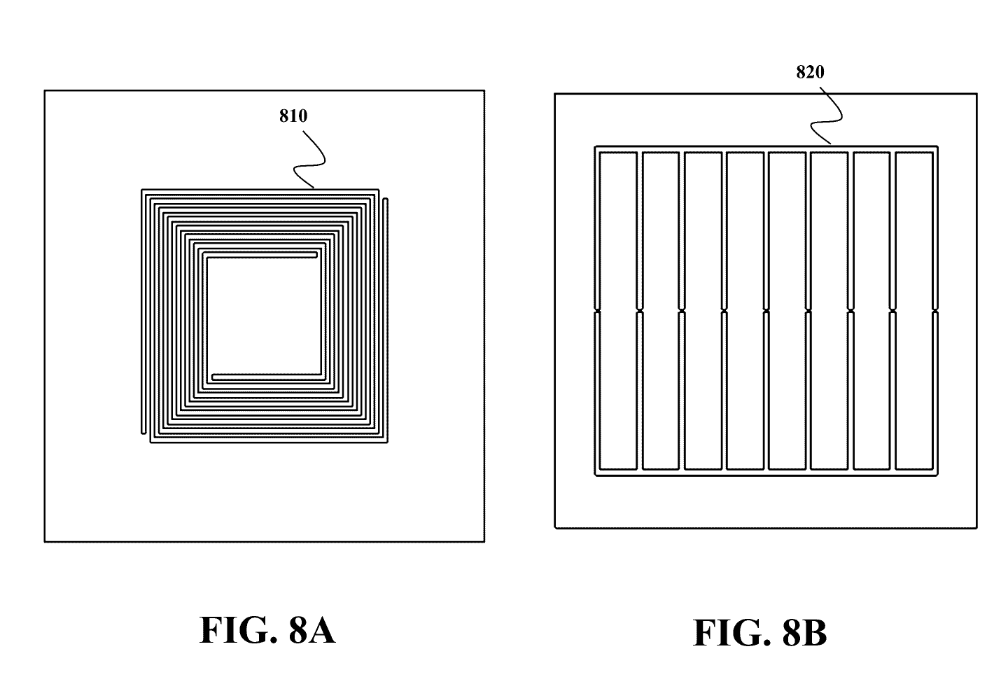

FIGS. 8A and 8B shows examples of different geometrical patterns of the detecting structure according to some embodiments of the invention. FIG. 8A shows an example of a multi-filer spirals designed as the resonant structure. Metamaterial resonators can also be used for the target structure. FIG. 8B shows an example of resonator 820 developed by metamaterial concept. The effective capacitance is provided by the small gaps in the middle of the structures, and the effective inductance is provided by the metallic wires. To further increase the quality factor of the resonance, other measures can be taken. For example, low loss dielectric materials are preferred as the substrate of the target structure.

The sensors can also be used as part of a larger sensor. For example, multiple resonant structures can form target structure, which can serve as a marker of positions or a linear scale. The sensing structure formed by the source and detecting structures can also include multiple pairs of differential coils. In this case, multiple output channels can extend linear sensing range or form a linear encoder.

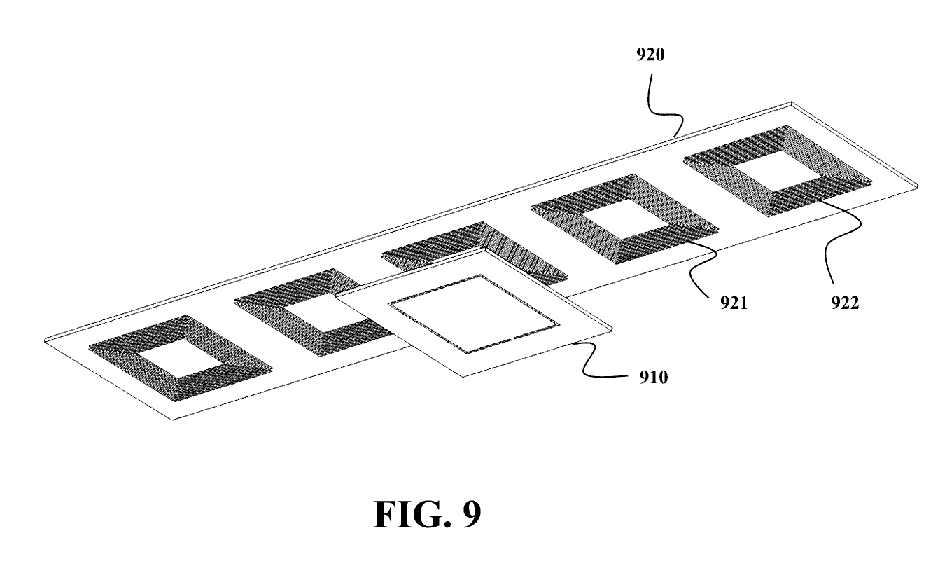

FIG. 9 shows a schematic of the sensing structure 910 detecting a position of the target structure 920 including multiple resonant structures 921 and 922 according to one embodiment of the invention. The resonant structures can be of the same or different designs, and can have the same or different resonant frequencies. The induced magnetic field on the target structure is different at different positions, and impacts the induced voltages differently. Thus the target structure serves as a scale corresponding to different positions, and can be utilized by the sensor to determine the position information.

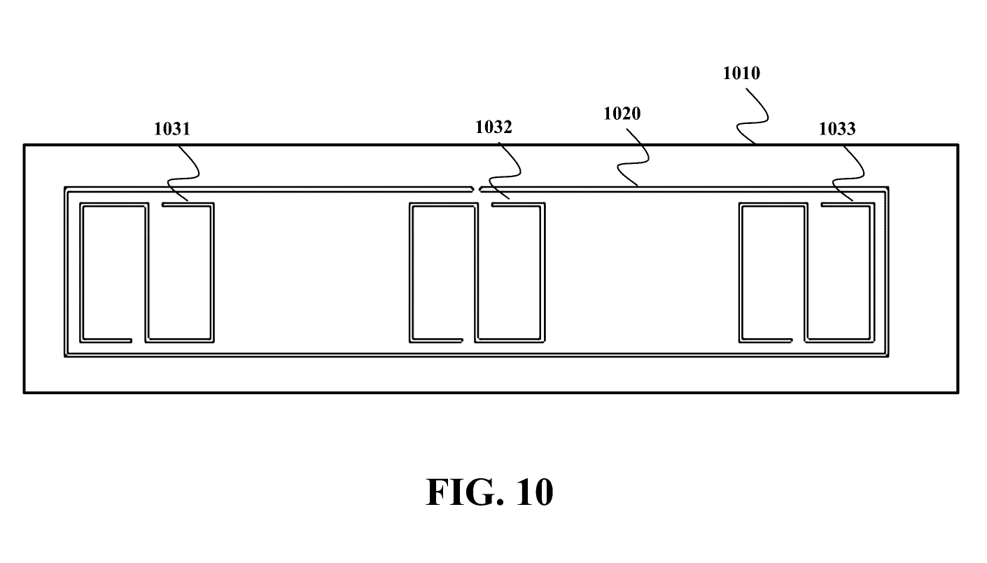

FIG. 10 shows a schematic of the sensing structure 1010 including a source structure 1020 and a set of groups 1031, 1032, 1033 of connected coils of the detecting unit according to one embodiment. In this embodiment, the processor can determine the relative position of the target structure based on a combination of values of voltages determined across each coil of the detecting unit, which serve as three independent measurement channels. The measured voltage values are different for the three channels, due to the different impact of the target structure.

In those embodiments, the resonant structures can be of the same or different designs, and can have the same or different resonant frequencies. The induced magnetic field on the target structure is different at different positions, and impacts the induced voltages differently. Thus the target structure serves as a scale corresponding to different positions, and can be utilized by the sensor to determine the position information. The three measurement channels can determine the position of the target structure independently. Thus the additional channels can serve as redundancy as the first channel. In case there is an object in the vicinity of one channel and impacting the measurement, the redundant channels help obtain the correct position information. Because the relative positions between the three measurement channels are known, the multiple channels can also work together and serve as part of a linear encoder.

The above-described embodiments of the present invention can be implemented in any of numerous ways. For example, the embodiments may be implemented using hardware, software or a combination thereof. Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

We claim:

1. A sensor, comprising:
a source including an electromagnetic structure generating an electromagnetic near-filed upon receiving energy;
a detecting unit including at least one coil arranged in proximity to the source such that the electromagnetic near-filed induces, via an inductive coupling, a current passing through the coil;
a measuring unit for measuring a voltage across the coil; and
a processor for detecting a presence of a target structure in proximity to the source upon detecting a change in a value of the voltage, wherein the target structure is an electromagnetic structure moving at a distance from the source.

2. The sensor of claim 1, further comprising:
a power source for supplying the energy to the source via a power signal having a resonance frequency, wherein the target structure is a resonant electromagnetic structure with the resonant frequency.

3. The sensor of claim 1, wherein the detecting unit includes a pair of connected coils including a first coil and a second coil, wherein the value of the voltage measured by the measurement unit represents a difference between a first voltage across the first coils and a second voltage across the second coil, and wherein the processor determines a relative position of the target structure with respect to the source based on the value of the voltage.

4. The sensor of claim 3, wherein the resonant structure moves according to a trajectory in a plane parallel to the electromagnetic structure of the source, further comprising:
a memory storing a mapping between a set of positions of the target structure on the trajectory and a set of values of the voltages, wherein the processor determines the relative position of the target structure using the mapping.

5. The sensor of claim 1, wherein the detecting unit includes a pair of connected coils including a first coil and a second coil, wherein the measurement unit measures the voltage across each connected coils including a first voltage measured across the first coils and a second voltage measured across the second coil, and wherein the processor compares the first voltage and the second voltage to determine a relative position of the target structure with respect to the source.

6. The sensor of claim 4, wherein the resonant structure moves according to a trajectory in a plane parallel to the electromagnetic structure of the source, further comprising:
a memory storing a mapping between a set of positions of the target structure on the trajectory and a set of corresponding differences between the first and the second voltages, wherein the processor determines the relative position of the target structure using the mapping.

7. The sensor of claim 1, wherein the detecting unit includes a pair of connected coils including a first coil and a second coil, wherein the measurement unit measures the voltage across each connected coils including a first voltage measured across the first coils and a second voltage measured across the second coil, and wherein the processor determines a relative position of the target structure with respect to the source based on the first voltage and the second voltage.

8. The sensor of claim 7, further comprising:
a memory storing a mapping between a set of different relative positions of the target structure and a set of corresponding pairs of values of the first and the second voltages, wherein the processor determines the relative position of the target structure using the mapping.

9. The sensor of claim 3, wherein the connected coils have identical shape and are centered with respect to the electromagnetic structure of the source such that a difference between the first and the second voltages is below a threshold when the target structure is outside the electromagnetic near-field.

10. The sensor of claim 3, wherein the processor determines the relative position of the target structure to be aligned with the connected coils if the difference between the first and the second voltages during the presence of the target structure within the electromagnetic near field equals a difference between the first and the second voltages when the target structure is outside the electromagnetic near-field.

11. The sensor of claim 3, wherein the processor compares magnitudes of the first and the second voltages with reference voltages to detect a presence of the target structure within the electromagnetic near field.

12. The sensor of claim 3, wherein the detecting unit includes a plurality of connected coils, and wherein the processor determines the relative position of the target structure based on a combination of values of voltages determined across each coil of the detecting unit.

13. The sensor of claim 3, wherein the detecting unit includes a set of groups of connected coils, and wherein the processor determines the relative position of the target structure based on a combination of values of voltages determined across each coil of the detecting unit.

14. The sensor of claim 1, wherein the coil of the detecting unit is an 8-shaped coil.

15. The sensor of claim 1, wherein the coil of the detecting unit and the electromagnetic structure of the source are arranged on a printed circuit board.

16. The sensor of claim 1, wherein the target structure includes multiple resonant structures.

17. A sensor, comprising:
a source including an electromagnetic structure;
a power source for supplying a power signal with the resonance frequency to the electromagnetic structure to generate a magnetic near-filed around the electromagnetic structure;
a detecting unit including connected coils arranged in proximity to the source such that the magnetic near-filed induces a current passing through the connected coils via an inductive coupling, wherein connected coils includes a first coil and a second coil;
a measurement unit for measuring voltages across each connected coils including a first voltage measured across the first coils and a second voltage measured across the second coil; and
a processor for comparing the first voltage and the second voltage and for determining a relative position of a target structure with respect to the source or with respect to the pair of connected coils based on a difference between the first and the second voltages.

18. The sensor of claim 17, wherein the target structure moves according to a trajectory, and wherein the sensor further comprising:
a memory storing a mapping between a set of positions of the target structure on the trajectory and a set of pairs of the first and the second voltages.

19. The sensor of claim 17, wherein the processor determines the position of the target structure to be aligned with connected coils if the difference between the first and the second voltages during the presence of the target structure within the magnetic near field is equal to the difference between the first and the second voltages when the target structure outside the magnetic near-field.

20. The sensor of claim 17, wherein the processor compares magnitudes of the first and the second voltages with reference voltages to detect a presence of the target structure within the magnetic near field.
